(19) United States
(12) Patent Application Publication
(10) Pub. No.: US 2025/0175308 A1
(43) Pub. Date: May 29, 2025

(54) INFORMATION INDICATION APPARATUS, INFORMATION RECEPTION APPARATUS AND METHODS THEREOF

(71) Applicant: FUJITSU LIMITED, Kawasaki-shi (JP)

(72) Inventors: Jing ZHU, Beijing (CN); Lei ZHANG, Beijing (CN)

(73) Assignee: FUJITSU LIMITED, Kawasaki-shi (JP)

(21) Appl. No.: 19/039,889

(22) Filed: Jan. 29, 2025

Related U.S. Application Data
(63) Continuation of application No. PCT/CN2022/111479, filed on Aug. 10, 2022.

(51) Int. Cl. H04L 5/00; H04W 72/23

(52) U.S. Cl. CPC H04L 5/0057; H04W 72/23

(57) ABSTRACT

An information indication apparatus, applicable to a network device, includes: a transmitter configured to transmit indication information to a terminal equipment, wherein the indication information indicates: activation/deactivation of a channel state information (CSI) report in a list of CSI reports; and, enabling/disabling of at least one channel state information reference signal (CSI-RS) resource within a CSI-RS resource set; and a receiver, configured to receive a channel state information (CSI) report on a physical uplink shared channel (PUSCH) or a physical uplink control channel (PUCCH).

### CROSS-REFERENCE TO RELATED APPLICATION

This application is a continuation application of International Application PCT/CN2022/111479 filed on Aug. 10, 2022, and designated the U.S., the entire contents of which are incorporated herein by reference.

### TECHNICAL FIELD

Embodiments of the present disclosure relate to the field of communication technology.

### BACKGROUND

Network energy saving has important significance for environmental sustainability, reducing impacts (greenhouse gas emission) on environment and saving operating costs. With the popularity of the 5th generation mobile communication technology (5G) in industries and geographical regions, processing more advanced services and applications requires very high data rates, network deployment becomes denser, and more antennas, greater bandwidths and more frequency bands are used. Impacts of 5G on environment need to be controlled, and new solutions need to be developed to improve network energy saving.

Energy consumption has become an important part of operators' operating costs. According to a report of the Global System for Mobile Communications Association (GSMA), energy costs for mobile networks account for about 23% of operators' total costs. Most of the energy consumption comes from wireless access networks, especially active antenna units (AAUs), data centers and optical fiber transmission account for a smaller share. Power consumption of wireless access may be divided into two parts: a dynamic part is consumed only when data transmission/reception is in progress, and a static part is consumed all the time to maintain necessary operations of a wireless access device, even if the data transmission/reception is not in progress.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

Currently, due to introduction of technologies such as large bandwidth/multi-antenna/multi-channel, energy consumption of a base station is relatively large, which has become one of the most urgent problems to be solved by global operators.

Current Release 18 (R18) phase introduces a network energy-saving issue. Network energy-saving technology may be divided into types such as time domain/frequency domain/spatial domain/energy domain, but in practical applications, it is more likely to use through a combination of two or more types of energy-saving technologies. For example, in the aspect of spatial energy-saving technology, the purpose of energy saving may be achieved by adjusting spatial elements. Spatial elements include a logical antenna port, a transmitting and receiving unit (TXRU), a Tx chain, an array antenna factor, etc. In the aspect of time domain energy-saving technology, energy saving may be achieved via a method of a cell ON/OFF or reducing a common channel/signal transmission; and in the aspect of frequency domain energy-saving technology, energy saving may be achieved via a method such as switching a bandwidth part (BWP). Through the above energy-saving technologies, a network device enters an energy-saving mode (a power-saving mode or a dormant mode). When the network device changes between a normal (regular) mode and the energy-saving mode, terminal related processing is affected, including update of a channel state information (CSI) measurement mode, update of channel state information (CSI) report, update of a channel state information reference signal (CSI-RS) resource, and switching of a bandwidth part (BWP), etc. The above related processing is a basis for the network device to schedule a terminal equipment to receive and transmit data. The above related processing further involves configuring and indicating by the network device to the terminal equipment, and reporting from the terminal equipment to the network device.

How to make the network device and the terminal equipment adapt to impacts of different modes without ambiguity is a key problem i.e., whether a network energy-saving technology may be applied in actual deployment, which needs to be solved urgently.

For at least one of the above problems, embodiments of the present disclosure provide an information indication apparatus and an information reception apparatus and methods for same A network device changes a service mode and transmits indication information to a terminal equipment, wherein the indication information indicates: update of a CSI measurement mode; and/or, update of a CSI report; and/or, update of a CSI-RS resource; and/or, switching of a BWP. Hence, the terminal equipment may adapt to a changed service mode without ambiguity via the indication information, and accurately determine information such as update of a CSI measurement mode and/or update of CSI report and/or update of a CSI-RS resource and/or switching of a BWP, so as to further efficiently perform subsequent uplink data transmission or downlink data reception with the network device.

According to one aspect of embodiments of the present disclosure, an information indication apparatus is provided, applicable to a network device, the apparatus includes:
a changing unit configured to change a service mode; and
a transmitting unit configured to transmit indication information to a terminal equipment, wherein the indication information indicates: update of a channel state information (CSI) measurement mode; and/or, update of channel state information (CSI) report; and/or, update of a channel state information reference signal (CSI-RS) resource; and/or, switching of a bandwidth part (BWP).

According to another aspect of the embodiments of the present disclosure, an information reception apparatus is provided, applicable to a terminal equipment, the apparatus includes:
a receiving unit configured to receive indication information; and
a determining unit configured to determine the following according to the indication information: update of a channel state information (CSI) measurement mode; and/or, update of a channel state information (CSI) report; and/or, update of a channel state information reference signal (CSI-RS) resource; and/or, switching of a bandwidth part (BWP).

According to a further aspect of embodiments of the present disclosure, an information indication method is provided, applicable to a network device, the information indication method includes:
the network device changes a service mode, and
the network device transmits indication information to a terminal equipment, wherein the indication information indicates: update of a channel state information (CSI) measurement mode; and/or, update of a channel state information (CSI) report; and/or, update of a channel state information reference signal (CSI-RS) resource; and/or, switching of a bandwidth part (BWP).

According to a further aspect of embodiments of the present disclosure, an information reception method is provided, applicable to a terminal equipment, the information reception method includes:
the terminal equipment receives indication information; and
the terminal equipment determines the following according to the indication information: update of a channel state information (CSI) measurement mode; and/or, update of channel state information (CSI) report; and/or, update of a channel state information reference signal (CSI-RS) resource; and/or, switching of a bandwidth part (BWP).

One of advantageous effects of embodiments of the present disclosure lies in: a network device changes a service mode and transmits indication information to a terminal equipment, the indication information indicating: update of a CSI measurement mode; and/or, update of a CSI report; and/or, update of a CSI-RS resource; and/or, switching of a BWP, therefore, the terminal equipment may adapt to a changed service mode without ambiguity via the indication information, and accurately determine information such as update of a CSI measurement mode and/or update of CSI report and/or update of a CSI-RS resource and/or switching of a BWP, so as to further efficiently perform subsequent uplink data transmission or downlink data reception with the network device.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the spirit and terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of a communication system in embodiments of the present disclosure;

FIG. 2 is a schematic diagram of an information indication method in embodiments of the present disclosure;

FIG. 3 is an exemplary diagram of indication information in embodiments of the present disclosure;

FIG. 4 is an exemplary diagram of a CSI report in embodiments of the present disclosure;

FIG. 5 is an exemplary diagram of update of a CSI-RS resource in embodiments of the present disclosure;

FIG. 6 is an exemplary diagram of update of a CSI-RS port in embodiments of the present disclosure;

FIG. 7 is a schematic diagram of an information reception method in embodiments of the present disclosure;

FIG. 8 is a schematic diagram of an information indication apparatus in embodiments of the present disclosure;

FIG. 9 is a schematic diagram of an information reception apparatus in embodiments of the present disclosure;

FIG. 10 is a composition schematic diagram of a network device in embodiments of the present disclosure; and

FIG. 11 is a schematic diagram of composition of a terminal equipment in embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system can be carried out according to a communication protocol at any stage, for example may include but be not limited to the following communication protocols: 1G (generation), 2G, 2.5G, 2.75G, 3G, 4G, 4.5G, 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB), a 5G base station (gNB) and an IAB donor, etc., and may further includes a Remote Radio Head (RRH), a Remote Radio Unit (RRU), a relay or a low power node (such as femeto, pico, etc.). And the term “base station” may include their some or all functions, each base station may provide communication coverage to a specific geographic region. The term “cell” may refer to a BS and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services through a network device. The terminal equipment may be fixed or mobile, and may also be referred to as Mobile Station (MS), a terminal, Subscriber Station (SS), Access Terminal (AT) and a station and so on; for example, “user equipment” and “terminal equipment” may also be used interchangeably.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a wearable device, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, an industrial wireless equipment, a surveillance camera, a Device to Device (D2D) terminal, a Machine to Machine (M2M) terminal and so on.

Moreover, the term “a network side” or “a network device side” refers to a side of a network, may be a base station or a core network device, and may include one or more network devices as described above. The term “a user side” or “a terminal side” or “a terminal equipment side” refers to a side of a user or terminal, may be a UE, and may include one or more terminal equipments as described above. If it is not specifically mentioned herein, “a device” may refer to a network device, or may refer to a terminal equipment.

In the following description, without causing confusion, the terms “uplink control signal” and “Uplink Control Information (UCI)” or “Physical Uplink Control Channel (PUCCH)” are interchangeable, the terms “uplink data signal” and “uplink data information” or “Physical Uplink Shared Channel (PUSCH)” are interchangeable, “cell” and “carrier” and “serving cell” and “carrier component” are interchangeable. The terms “downlink control signal” and “Downlink Control Information (DCI)” or “Physical Downlink Control Channel (PDCCH)” are interchangeable, the terms “downlink data signal” and “downlink data information” or “Physical Downlink Shared Channel (PDSCH)” are interchangeable, DCI and DCI format are interchangeable.

Moreover, transmitting or receiving a PUSCH may be understood as transmitting or receiving uplink data carried by a PUSCH, transmitting or receiving a PUCCH may be understood as transmitting or receiving uplink information (e.g. UCI) carried by a PUCCH, transmitting or receiving a PRACH may be understood as transmitting or receiving a preamble carried by a PRACH; transmitting or receiving a PDSCH may be understood as transmitting or receiving downlink data carried by a PDSCH, transmitting or receiving a PDCCH may be understood as transmitting or receiving downlink information (e.g. DCI) carried by a PDCCH.

In the embodiments of the present disclosure, high layer signaling may be e.g. radio resource control (RRC) signaling; the RRC signaling includes, for example, an RRC message, for example includes a master information block (MIB), system information, and a dedicated RRC message; or an RRC information element (RRC IE); or an information field included by an RRC message or an RRC information element (or an information field included by the information field). The high layer signaling, for example, may further be Medium Access Control (MAC) signaling; or called a MAC control element (MAC CE). However, the present disclosure is not limited to this.

Scenarios of the embodiments of the present disclosure are described through the following examples, however the present disclosure is not limited to these.

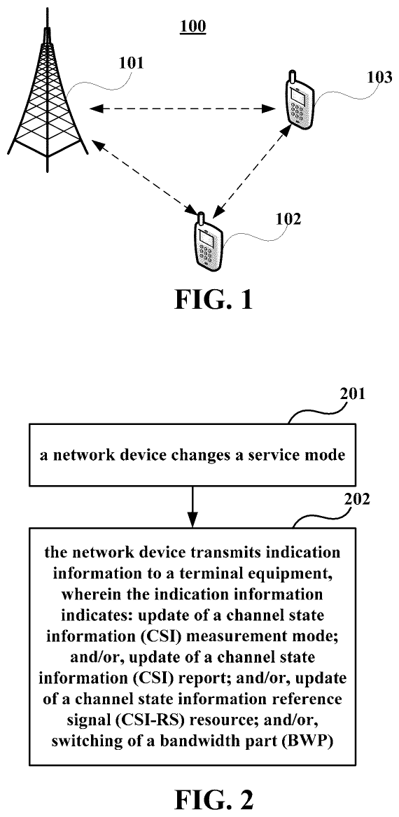

FIG. 1 is a schematic diagram of a communication system in the embodiments of the present disclosure, schematically describes situations by taking a terminal equipment and a network device as examples, as shown in FIG. 1, a communication system 100 may include a network device 101 and terminal equipments 102, 103. For simplicity, FIG. 1 only takes two terminal equipments and one network device as examples for description, however the embodiments of the present disclosure are not limited to this.

In the embodiments of the present disclosure, transmission of existing or further implementable services may be carried out between the network device 101 and the terminal equipments 102, 103. For example, these services may include but be not limited to: enhanced Mobile Broadband (eMBB), massive Machine Type Communication (mMTC), Ultra-Reliable, Low-Latency Communication (URLLC) and relevant communication of a terminal equipment with reduced capacities, etc.

It is worth noting that FIG. 1 shows that two terminal equipments 102 and 103 are within the coverage of network device 101, but the present disclosure is not limited to this. The two terminal equipments 102 and 103 may be outside the coverage of the network device 101, or one terminal equipment 102 may be within the coverage of the network device 101 and the other terminal equipment 103 may be outside the coverage of the network device 101.

Current Release 18 (R18) phase introduces a network energy-saving issue. Network energy-saving technology may be divided into types such as time domain/frequency domain/spatial domain/energy domain, but in practical applications, it is more likely to use through a combination of two or more types of energy-saving technologies. For example, in the aspect of spatial energy-saving technology, the purpose of energy saving may be achieved by adjusting spatial elements. Spatial elements include a logical antenna port, a transmitting and receiving unit (TXRU), a Tx chain, an array antenna factor, etc. In the aspect of time domain energy-saving technology, energy saving may be achieved via a method of a cell ON/OFF or reducing common signal transmission; and in the aspect of frequency domain energy-saving technology, energy saving may be achieved via a method such as switching a bandwidth part (BWP). Through the above energy-saving technologies, a network device enters an energy-saving mode (power-saving mode or dormant mode). When the network device changes between a normal (regular) mode and the energy-saving mode, terminal related processing will be affected, including update of a channel state information (CSI) measurement mode, update of channel state information (CSI) report, update of a channel state information reference signal (CSI-RS) resource, and switching of a bandwidth part (BWP), etc. The above related processing is a basis for the network device to schedule a terminal equipment to receive and transmit data. The above related processing further involves configuring and indicating by the network device to the terminal equipment, and reporting from the terminal equipment to the network device.

By taking the spatial energy-saving technology as an example, at least one energy-saving mode or normal (regular) mode may be changed by adjusting the number of spatial elements, and in the process of achieving energy saving by adjusting the number of spatial elements, the terminal equipment may change a CSI measurement mode; in addition, in principle, the number of spatial elements should not be less than the number of CSI-RS ports, otherwise a CSI-RS cannot be configured normally; in the process of achieving energy saving by adjusting the number of spatial elements, when the energy-saving mode is turned on or off, the number of spatial elements may be caused to be less than the number of CSI-RS ports, and thus it is necessary to update CSI-RS time-frequency-space resources.

Therefore, how to make the network device and the terminal equipment adapt to impacts of different modes without ambiguity is a key problem i.e., whether a network energy-saving technology may be applied in actual deployment, which needs to be solved urgently. For at least one of the above problems, embodiments of the present disclosure provide an information indication apparatus and an information reception apparatus and method.

### Embodiments of a First Aspect

Embodiments of the present disclosure provide an information indication method, which is described from a network device side.

FIG. 2 is a schematic diagram of an information indication method in embodiments of the present disclosure, as shown in FIG. 2, the method includes:
201, a network device changes a service mode; and
202, the network device transmits indication information to a terminal equipment, wherein the indication information indicates: update of a channel state information (CSI) measurement mode; and/or, update of a channel state information (CSI) report; and/or, update of a channel state information reference signal (CSI-RS) resource; and/or, switching of a bandwidth part (BWP).

Thus, the terminal equipment may adapt to a changed service mode without ambiguity via the indication information, and accurately determine information such as update of a CSI measurement mode and/or update of CSI report and/or update of a CSI-RS resource and/or switching of a BWP, so as to further efficiently perform subsequent uplink data transmission or downlink data reception with the network device.

In some implementations, the service mode includes a normal mode and/or at least one energy-saving mode.

For example, “at least one energy-saving mode” may include at least one of the following modes: “an energy-saving mode”, “a light energy-saving mode”, “a deep energy-saving mode”, or “an energy-saving transition mode”, etc., the present disclosure does not make limitations in this regard; the above “normal mode” may further be replaced with “a common mode”; the above “energy-saving mode” may further be replaced with “a power-saving mode” or “a sleep mode” or “a dormant mode” or “an OFF mode” and other expressions, the present disclosure does not make limitations in this regard.

In some implementations, the service mode may be changed by changing “a spatial element” or changing “an antenna mode”, for example, by turning off some of “the spatial elements”, a network is changed from “the normal mode” to “the energy-saving mode”.

In some implementations, “the spatial element” includes at least one of the following: a logical antenna port, a transmitting and receiving unit (TXRU), a Tx chain, or an array antenna factor, etc.; in some implementations, “the spatial element” may further be directly replaced with “a power saving mode”; “determine to turn on or off at least some of spatial elements” may further be replaced with “determine to turn on or off an energy-saving mode”; or “determine to turn on or off at least some of spatial elements” may further be replaced with “determine to activate or deactivate an energy-saving mode”.

In some implementations, in terms of time-domain energy-saving technology, energy saving may be achieved via a method for cell ON/OFF or reducing common signal transmission. For example, a network may be changed from “a normal mode” to “an energy-saving mode” by turning off some cells.

In some implementations, in terms of frequency domain energy-saving technology, energy saving may be achieved through a method such as switching a bandwidth part (BWP). For example, “the normal mode” or “the energy-saving mode” is configured with a specific bandwidth part (BWP).

In some implementations, the network device further transmits configuration information to the terminal equipment, wherein the configuration information configures a first timer associated with one of at least one energy-saving mode, wherein the first timer sets an application time of one of the at least one energy-saving mode.

For example, the network device transmits the configuration information via higher-layer signaling, such as RRC signaling, wherein the configuration information indicates an application time of the power-saving mode via the first timer, such as 300 ms.

For example, after reading RRC signaling, the terminal equipment obtains the application time of the energy-saving mode, the network device changes a service mode (for example, from the normal mode to the energy-saving mode) and transmits indication information to the terminal equipment, the terminal equipment performs update of a CSI measurement mode, and/or update of a CSI report, and/or update of a CSI-RS resource, and/or switching of a BWP, and resumes the normal mode after 300 ms, descriptions will be made subsequently by combining with specific content of the indication information.

In some implementations, the network device transmits the indication information via semi-static signaling or dynamic signaling.

For example, if the indication information is transmitted by using RRC signaling, for example a RRC reconfiguration process is used, it is implemented as a millisecond level, too large delay goes against supporting a dynamic energy-saving mode, the dynamic energy-saving mode may be of symbol or slot level (less than millisecond). For another example, under normal circumstances, a CSI-RS resource and CSI measurement of a user do not need to be changed frequently, but in the process of an energy-saving operation, the normal mode and the energy-saving mode is switched frequently, and using an RRC signaling process brings large overhead and causes a waste of system resources. Thus, transmitting the indication information via semi-static signaling or dynamic signaling in the above implementations of the present disclosure may further reduce delay and overhead of signaling, and may support switching of the dynamic energy-saving mode.

In some implementations, the semi-static signaling may be MAC CE signaling; the dynamic signaling may be downlink control information (DCI). For example, the dynamic signaling is DCI, the indication information is carried via the DCI, the DCI may be a new added DCI format for the energy-saving mode, or an existing DCI format may be reused, the present disclosure does not make limitations in this regard. For example, in the case of introducing the new added DCI format, the DCI format may be scrambled by introducing a new Radio Network Temporary Identity (RNTI) such as an ES-RNTI (energy saving-RNTI), or a specific time-frequency resource may further be allocated for this new DCI format, so that the terminal equipment may recognize the DCI, the present disclosure does not make limitations in this regard.

In some implementations, the indication information may be transmitted to the terminal equipment via signaling indicating that a service mode is changed; for example, the terminal equipment may be indicated via the DCI to activate/deactivate “an energy-saving mode”, the indication information may be carried via the DCI; optionally, the indication information and the signaling indicating that a service mode is changed may further be transmitted respectively, the present disclosure does not make limitations in this regard.

In some implementations, the semi-static signaling or the dynamic signaling is group signaling, and the network device transmits indication information to multiple terminal equipments via the group signaling; or, the semi-static signaling or the dynamic signaling is UE-specific signaling, and the network device transmits indication information to a terminal equipment via the UE-specific signaling.

In some implementations, the indication information indicates: update of a CSI measurement mode; and/or, update of a CSI report; and/or, update of a CSI-RS resource; and/or, switching of a BWP. The following text will schematically describe indications of the indication information respectively.

The following text specifically describes how to indicate update of the CSI measurement mode.

For example, “CSI measurement mode” means that the terminal equipment performs “merge processing” or “unmerge processing” on a CSI measurement result; for example, “merge processing” may further be replaced with “merge averaging” or “smooth filtering”; for specific implementations of “merge processing” or “smooth filtering”, related arts may be referred to, the present disclosure does not make limitations in this regard.

For example, in “the normal mode” (“non-power-saving mode”), the terminal equipment generally performs merge processing on all CSI measurement results; however, in a case where “the energy-saving mode” is enabled, transmission power of a channel state indication reference signal (CSI-RS) changes, and the last CSI measurement mode after “the normal mode” is changed to “the energy-saving mode” should also change accordingly to reflect a channel quality state in real time. For example, when “the normal mode” is changed to “the energy-saving mode”, if the terminal equipment still performs merge processing on CSI measurement results, CSI measurement results of “the normal mode” and “the energy-saving mode” may be possibly merged. Thus, a merged CSI measurement result is not able to truly reflect a channel state of the energy-saving mode. Implementations of the present disclosure may enable the terminal equipment timely obtain whether the CSI measurement mode is changed or not via the indication information, and thus CSI measurement may be carried out more accurately.

In some implementations, the network device indicates, via the indication information indicating the update of CSI measurement mode and/or the first timer, whether the CSI measurement mode is changed or not.

In some implementations, in a case where the network device changes the service mode, the indication information indicates, via a value of one or more bits, to change the CSI measurement mode, and/or, indicates, via another value of the one or more bits, not to change the CSI measurement mode.

In some implementations, in a case where the semi-static signaling or the dynamic signaling is group signaling, the indication information is a bitmap including multiple blocks.

For example, each block corresponds to a terminal equipment, and a starting position and/or size of each block is/are configured by high-layer signaling.

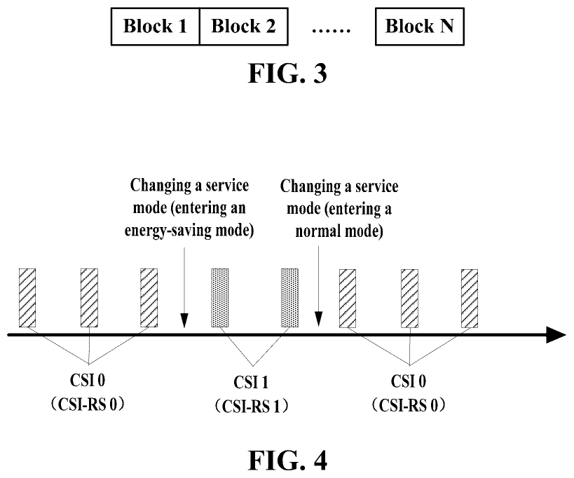

FIG. 3 is an exemplary diagram of indication information in embodiments of the present disclosure.

For example, each block represents indication information of a terminal equipment, and a starting position and/or size of each block is/are given by a higher-layer parameter, for example, a higher-layer parameter in the existing standard may be used, or a new higher-layer parameter may be introduced, the present disclosure does not make limitations in this regard.

By taking each block being 1 bit as an example, the network device may indicate whether a CSI measurement mode of a specific terminal equipment is changed or not via 1 bit, for example, the bit is “1”, in order to change the CSI measurement mode, it may also be said that CSI measurement merge processing is not performed; the bit is “0”, in order not to change the CSI measurement mode, it may also be said that CSI measurement merge processing is performed.

For example, for five terminal equipments, the meaning of specific content “11010” of the indication information is: for the first, second and fourth terminal equipments, CSI measurement merge processing is not performed; for the third and fifth terminal equipments, CSI measurement merge processing is performed. By taking the third terminal equipment as an example, the indication information obtained by the third terminal equipment via higher-layer signaling is 5 bits in total, wherein a size of each block is 1 bit, thus the third terminal equipment may determine that the third bit (value thereof is “0”) is an indication bit of the third terminal equipment.

In some implementations, if the CSI measurement mode of the terminal equipment is changed, the indication information carries a corresponding block of the terminal equipment; and if the CSI measurement mode of the terminal equipment is not changed, the indication information does not carry the corresponding block of the terminal equipment. For example, if the terminal equipment fails to read relevant fields of the indication information via higher-layer signaling, it is considered that the CSI measurement mode is not changed, and an original CSI measurement mode is still used.

In some implementations, the semi-static signaling or the dynamic signaling is UE-specific signaling. For example, the network device may indicate whether a CSI measurement mode is changed or not via 1 bit, for example, the bit is “1”, in order to change the CSI measurement mode, it may also be said that CSI measurement merge processing is not performed; the bit is “0”, in order not to change the CSI measurement mode, it may also be said that CSI measurement merge processing is performed.

The above bit content is only exemplary description, a bit may further be set to be “0”, in order to change the CSI measurement mode, it may also be said that CSI measurement merge processing is not performed; the bit is “1”, in order not to change the CSI measurement mode, the present disclosure does not make limitations in this regard.

In some implementations, the terminal equipment changes the CSI measurement mode after the first timer expires.

For example, the network device transmits the configuration information via higher-layer signaling, such as RRC signaling, wherein the configuration information indicates an application time of the power-saving mode. For example, after reading RRC signaling, the terminal equipment obtains the application time of the energy-saving mode, the network device changes a service mode (for example, from the normal mode to the energy-saving mode) and transmits indication information to the terminal equipment (using said indication method), the terminal equipment performs update of a CSI measurement mode, for example does not perform merge processing when the normal mode is changed to the energy-save mode, and resumes the normal mode after 300 ms, and changes the CSI measurement mode, for example does not perform merge processing on CSI measurements when 300 ms expires.

Thus, the terminal equipment may obtain specific content of the indication information, and may perform CSI measurements more accurately.

The following text specifically describes how to indicate update of the CSI report.

In some implementations, the network device activates/deactivates, via the indication information indicating the update of CSI report and/or the first timer, at least one CSI report.

In some implementations, in a case where the network device changes a service mode, the indication information indicates to activate first CSI report and/or deactivate second CSI report, wherein the first CSI report and/or the second CSI report is/are configured by higher-layer information.

In some implementations, the first CSI report and/or the second CSI report belong(s) to a first CSI report list which includes a CSI report configuration index (CSI-ReportConfigId), wherein the first CSI report list and the CSI report configuration index (CSI-ReportConfigId) are configured by higher-layer information.

For example, each CSI report corresponds to a CSI report configuration index (CSI-ReportConfigId), for example, CSI report corresponding to a CSI report configuration index (CSI-ReportConfigId)=0 is: CSI 0.

For example, the first CSI report list contains which CSI reports are configured by higher-layer signaling. For example, the higher-layer signaling configures the first CSI report list to contain five CSI reports, corresponding to “CSI 0” to “CSI 4” respectively; the terminal equipment determines to activate/deactivate which specific CSI report according to the indication information. The Specification will illustrate with examples in the subsequent contents by further combining with implementations.

In some implementations, wherein the CSI report configuration index (CSI-ReportConfigId) included in the first CSI report list is associated with a change of at least one piece of the following information:
a CSI report period and offset, for example indicating via the following fields “CSI-ReportPeriodicity AndOffset”, “reportSlotConfig” and “reportSlotOffsetList” of higher-layer signaling;
a resource used for CSI report, for example indicating via the following field “pucch-CSI-ResourceList” of higher-layer signaling;
a period and offset of a CSI-RS resource to which the CSI report is bound, for example indicating via the following field “ResourceConfig” of higher-layer signaling; or a time-frequency resource of a CSI-RS resource to which the CSI report is bound, for example indicating via the following field “CSI-ResourceConfig” of higher-layer signaling.

For example, the CSI report period may be longer in the energy-saving mode. For example, the CSI report period is 40 ms in the normal mode and 80 ms in the energy-saving mode. For example, a higher layer configures a period of CSI 0 to be 80 ms and a period of CSI 1 to be 40 ms, and the first CSI report list includes CSI 0 and CSI 1, and after the service mode is changed to the energy-saving mode, the indication information may indicate to activate CSI 0 (first CSI report) and deactivate CSI 1 (second CSI report). The Specification will illustrate with examples in the subsequent contents by further combining with implementations.

For another example, the CSI-RS resource to which the CSI report is bound in the energy-saving mode is CSI-RS 16 port, the CSI-RS resource to which the CSI report is bound in the normal mode is CSI-RS 32 port, for example a higher layer configures CSI 0 to be bound to CSI-RS 0 of 32 ports and CSI 1 to be bound to CSI-RS 1 of 16 ports, and the first CSI report list includes CSI 0 and CSI 1, and after the service mode is changed to the energy-saving mode, the indication information may indicate to activate CSI 1 (first CSI report) and deactivate CSI 0 (second CSI report), activating CSI 1 also means activating CSI-RS 1 of 16 ports to which it is bound, and deactivating CSI 0 also means deactivating CSI-RS 0 of 32 ports to which it is bound.

In some implementations, for a specific CSI report, the indication information indicates, via a value of one or more bits, to activate the CSI report, and indicates, via another value of the one or more bits, to deactivate the CSI report.

In some implementations, in a case where the semi-static signaling or the dynamic signaling is group signaling, the indication information is a bitmap including multiple blocks, wherein each block corresponds to a terminal equipment, and a starting position and/or size of each block is/are configured by high-layer signaling, each block includes one or more bits, each block indicates the first CSI report list of a terminal equipment, and each bit in each block corresponds to CSI report in the first CSI report list.

For example, still by taking the bitmap of multiple blocks shown in FIG. 3 as an example, each block represents indication information of a terminal equipment, and a starting position and/or size of each block is/are given by a higher-layer parameter, for example, a higher-layer parameter in the existing standard may be used, or a new higher-layer parameter may be introduced, the present disclosure does not make limitations in this regard.

For example, each block corresponds to a first CSI report list of a specific terminal equipment, each block e.g. includes X bits, wherein each of the X bits corresponds to an activation/deactivation state of one CSI report in the first CSI report list, the list may be given by a higher-layer parameter.

By taking a specific terminal equipment as an example, for example a higher-layer parameter configures the first CSI report list to include 5 CSI reports, corresponding to “CSI 0”-“CSI 4” respectively, an activation/deactivation state of each CSI report is indicated via 5 bits, for example “0” represents deactivating CSI report, “1” represents activating CSI report; for example, the higher-layer parameter configures a CSI period of “CSI 0” (first CSI report) to be 80 m and a CSI period of “CSI 1”-“CSI 4” (second CSI report) to be 40 m, “10000” may be transmitted to a user equipment, which means that is to activate “CSI 0” and to deactivate “CSI 1”-“CSI 4”.

For example, for five terminal equipments, the indication information are “10000′ ‘10100’ ‘00011’ ‘00100’ ‘10001’”; by taking a second terminal equipment as an example, the indication information obtained by the second terminal equipment via higher-layer signaling is 25 bits in total, with 6 bits at a starting position, and the size of indication information of the terminal is 5 bits, i.e., the sixth to tenth bits are indication bits of the second terminal equipment, in which ‘10100’ indicates, for the second terminal equipment, activating “CSI 0” (first CSI report) and “CSI 2” (first CSI report), and deactivating “CSI 1” (second CSI report), “CSI 3” (second CSI report) and “CSI 4” (second CSI report). The above is only exemplary description. For example, the first CSI report list may be different for different terminal equipments.

In some implementations, if CSI report activation/deactivation states of the terminal equipment need to be update, the indication information carries a corresponding block of the terminal equipment; and if CSI report activation/deactivation states of the terminal equipment do not need to be updated, the indication information does not carry the corresponding block of the terminal equipment. For example, if the terminal equipment fails to read relevant fields of the indication information via higher-layer signaling, it is considered that CSI report activation/deactivation states do not need to be updated.

The above bit content is only exemplary description, “0” may also be set to represent activating CSI report and “1” to represent deactivating CSI report, the present disclosure does not make limitations in this regard.

In some implementations, the first CSI report and/or the second CSI report include(s): periodic CSI report, semi-persistent CSI report or non-periodic CSI report; for example, for specific contents of periodic CSI report, semi-persistent CSI report or non-periodic CSI report, related arts may be referred to, the present disclosure does not make limitations in this regard.

FIG. 4 is an exemplary diagram of CSI report in embodiments of the present disclosure.

For example, for a specific terminal equipment, in a case where the terminal equipment is in a normal mode, CSI report configured for it is “CSI 0”, a CSI-RS resource bound to it is “CSI-RS 0”; in a case where the terminal equipment is in an energy-saving mode, CSI report configured for it is “CSI 1”, a CSI-RS resource bound to it is “CSI-RS 1”. For example, by combining with the above method for updating CSI report, in the case of changing a service mode into the energy-saving mode, indication information transmitted by a network device is “ . . . ‘01000’ . . . ”, corresponding updated and activated CSI report is “CSI 1”. For example, in the case of changing the service mode into the normal mode, indication information transmitted is “ . . . ‘10000’ . . . ”, corresponding updated and activated CSI report is “CSI 0”.

In some implementations, the semi-static signaling or the dynamic signaling is UE-specific signaling. For example, the network device may indicate a first CSI report list via X bits; each of the X bit specifically indicates activating CSI report or deactivating CSI report. For example, “1” represents activating CSI report, 0 represents deactivating CSI report. For example, content of each block adopting the above implementations, as specific content of UE-specific signaling, is transmitted to a specific terminal equipment. For a specific indication method, the above implementations may be referred to, repeated description is omitted here.

In some implementations, when a service mode is changed, the terminal equipment starts a first timer and suspends CSI report before the service mode is changed; and after the first timer expires, the terminal equipment resumes the CSI report before the service mode is changed.

For example, the network device transmits the configuration information via higher-layer signaling, such as RRC signaling, wherein the configuration information indicates an application time of the power-saving mode. For example, after reading RRC signaling, the terminal equipment obtains the application time of the energy-saving mode, the network device changes a service mode (for example, from the normal mode to the energy-saving mode) and transmits indication information to the terminal equipment (using said indication method), the terminal equipment updates activated/deactivated CSI report, suspends the activated/deactivated CSI report in the normal mode, and resumes the normal mode after 300 ms, i.e., the first timer expires, and resumes the activated/deactivated CSI report in the normal mode.

Thus, the terminal equipment may obtain specific content of the indication information, and may determine update of CSI report.

The following text specifically describes how to indicate update of a CSI-RS resource.

In some implementations, the network device activates/deactivates, via the indication information indicating the update of a CSI-RS resource and/or the first timer, at least one CSI-RS resource.

In some implementations, in a case where the network device changes a service mode, the indication information indicates to activate a first CSI-RS resource and/or deactivate a second CSI-RS resource, wherein the first CSI-RS resource and/or the second CSI-RS resource is/are configured by higher-layer information, wherein the first CSI-RS resource and/or the second CSI-RS resource is/are the same or different.

In some implementations, the first CSI-RS resource and/or the second CSI-RS resource belong(s) to a first CSI-RS resource set, wherein the first CSI-RS resource set includes CSI-RS resources, and/or CSI-RS ports; wherein an index of the first CSI-RS resource set and the number and indices of the CSI-RS resources included in the first CSI-RS resource set and/or the number and indices of the CSI-RS ports are configured by higher-layer information.

For example, higher-layer signaling configures the first CSI-RS resource set and its index, and the first CSI-RS resource set includes multiple CSI-RS resources and multiple CSI-RS ports and related configurations, wherein for related configurations of multiple CSI-RS resources and multiple CSI-RS ports, related arts may be referred to, the present disclosure does not make limitations in this regard.

The following text takes “the first CSI-RS resource and/or the second CSI-RS resource belong(s) to a first CSI-RS resource set, wherein the first CSI-RS resource set includes CSI-RS resources” as an example.

In some implementations, for a specific CSI-RS resource, the indication information indicates, via a value of one or more bits, to activate the CSI-RS resource, and indicates, via another value of the one or more bits, to deactivate the CSI-RS resource.

In some implementations, the CSI-RS resource includes a group of CSI-RS resources or a CSI-RS resource, the group of CSI-RS resources is configured by higher-layer signaling.

In some implementations, in a case where the semi-static signaling or the dynamic signaling is group signaling, the indication information is a bitmap including multiple blocks; wherein each block corresponds to a terminal equipment, and a starting position and/or size of each block is/are configured by high-layer signaling; each bit corresponds to a group of CSI-RS resources or a CSI-RS resource of the terminal equipment, and the number of the bits is configured by high-layer signaling.

For example, still by taking the bitmap of multiple blocks shown in FIG. 3 as an example, each block represents indication information of a terminal equipment, and a starting position and/or size of each block is/are given by a higher-layer parameter, for example, a higher-layer parameter in the existing standard may be used, or a new higher-layer parameter may be introduced, the present disclosure does not make limitations in this regard.

For example, each block corresponds to an activation/deactivation state of each CSI-RS resource in a CSI-RS resource set of a specific terminal equipment, for example each block includes X bits, each of the X bits corresponds to the activation/deactivation state of a CSI-RS resource. In some implementations, for specific settings of a CSI-RS resource set and its corresponding CSI-RS resources, related arts may be referred to, the present disclosure does not make limitations in this regard.

For example, the first CSI-RS resource set includes four CSI-RS resources, an activation/deactivation state of each CSI-RS resource is indicated via four bits, for example “0” represents deactivating the CSI-RS resource, “1” represents activating the CSI-RS resource; the meaning of “1010” is activation of “a CSI-RS resource 0” (the first CSI-RS resource), “a CSI-RS resource 2” (the first CSI-RS resource) and deactivation of “a CSI-RS resource 1” (the second CSI-RS resource) and “CSI-RS resource 3” (the second CSI-RS resource).

For example, for two terminal equipments, the indication information is “'1010′ ‘0101’”; by taking a first terminal equipment as an example, the indication information obtained by the first terminal equipment via higher-layer signaling is 8 bits in total, with 1 bit at a starting position, and lasting for 4 bits, i.e., the first to fourth bits are indication bits of the first terminal equipment; in which ‘1010’ indicates, for the first terminal equipment, activating “a CSI-RS resource 0”, “a CSI-RS resource 2” and deactivating “a CSI-RS resource 1” and “a CSI-RS resource 3”.

Optionally, the indication information may further indicate activation/deactivation states of a group of CSI-RS resources, for example “a CSI-RS resource 0” and “a CSI-RS resource 2” are Group 0; “a CSI-RS resource 1” and “a CSI-RS resource 3” are Group 1; for two terminal equipments, indication information is “‘10’ ‘01’”; by taking the first terminal equipment as an example, the indication information obtained by the first terminal equipment via higher-layer signaling is 4 bits in total, in which a size of each block is 2 bits, “a CSI-RS resource 0” and “a CSI-RS resource 2” are Group 0, “a CSI-RS resource 1” and “a CSI-RS resource 3” are Group 1, and the first to second bits are indication bits of the first terminal equipment; in which ‘10’ indicates, for the first terminal equipment, activating “a CSI-RS resource 0”, “a CSI-RS resource 2” and deactivating “a CSI-RS resource 1” and “a CSI-RS resource 3”.

In some implementations, if CSI-RS resource activation/deactivation states of the terminal equipment need to be update, the indication information carries a corresponding block of the terminal equipment; and if CSI-RS resource activation/deactivation states of the terminal equipment do not need to be updated, the indication information does not carry the corresponding block of the terminal equipment. For example, if the terminal equipment fails to read relevant fields of the indication information via higher-layer signaling, it is considered that CSI-RS resource activation/deactivation states do not need to be updated.

The above bit content is only exemplary description, “0” may also be set to represent activating a CSI-RS resource and “1” to represent deactivating the CSI-RS resource, the present disclosure does not make limitations in this regard.

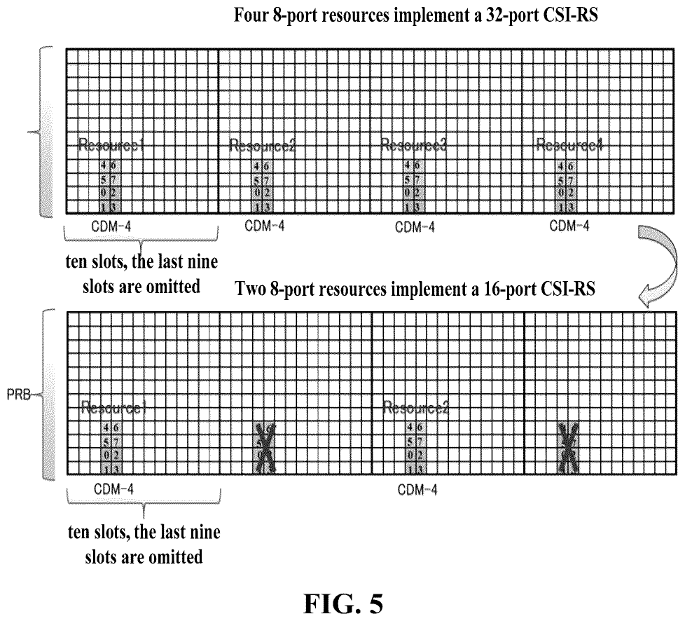

FIG. 5 is an exemplary diagram of update of a CSI-RS resource in embodiments of the present disclosure.

As shown in FIG. 5, for a 32-port CSI-RS, for example, the 32-port CSI-RS may be supported via CDM-4 and four resources, in which one resource of CDM-4 occupies eight resource elements (REs), and for CDM-4, related arts may be referred to, the present disclosure does not make limitations in this regard. In the normal mode, a specific terminal equipment uses a 32-port CSI-RS, and in the power-saving mode, the terminal equipment uses a 16-port CSI-RS, for example, in a case where a network device shuts down some of spatial elements, a CSI-RS resource of the terminal equipment is changed from activation of “Resource 1-Resource 4” in FIG. 5 to activation of “Resource 1, Resource3” and deactivation of “Resource 2, Resource4”. Thereby, update of a 32-port CSI-RS resource to a 16-port CSI-RS resource may be realized, for example, the mode indicated above is adopted, and it is not repeated here.

In some implementations, the semi-static signaling or the dynamic signaling is UE-specific signaling. For example, the network device may indicate activation/deactivation states of a CSI-RS resource included in a CSI-RS resource set via X bits; each of the X bits indicates activation/deactivation states of a specific CSI-RS resource, for example “1” is activation of a CSI-RS resource; “0” is deactivation of a CSI-RS resource; optionally, the network device may indicate activation/deactivation states of multiple groups of CSI-RS resources included in a CSI-RS resource set via X bits. For example, content of each block adopting the above implementations, as specific content of UE-specific signaling, is transmitted to a specific terminal equipment. For a specific indication method, the above implementations may be referred to, repeated description is omitted here.

In some implementations, after the first timer expires, the terminal equipment suspends a CSI-RS resource before the service mode is changed; and after the first timer expires, the terminal equipment resumes the CSI-RS resource before the service mode is changed.

For example, the network device transmits the configuration information via higher-layer signaling, such as RRC signaling, wherein the configuration information indicates an application time of the power-saving mode. For example, after reading RRC signaling, the terminal equipment obtains the application time of the energy-saving mode, the network device changes a service mode (for example, from the normal mode to the energy-saving mode) and transmits indication information to the terminal equipment (using said indication method), the terminal equipment updates an activated/deactivated CSI-RS resource, suspends the activated/deactivated CSI-RS resource in the normal mode, and resumes the normal mode after 300 ms, i.e., the first timer expires, and resumes the activated/deactivated CSI-RS resource in the normal mode.

Thus, the terminal equipment may obtain specific content of the indication information, and may determine updated activated/deactivated CSI-RS resources.

The following text takes “the first CSI-RS resource and/or the second CSI-RS resource belong(s) to a first CSI-RS resource set, wherein the first CSI-RS resource set includes CSI-RS ports” as an example.

In some implementations, the indication information indicates, via a value of one or more bits, to deactivate the CSI-RS port, and indicates, via another value of the one or more bits, to activate the CSI-RS port.

In some implementations, the CSI-RS port includes a group of CSI-RS ports or one CSI-RS port, the group of CSI-RS ports is configured by higher-layer signaling.

In some implementations, in a case where the semi-static signaling or the dynamic signaling is group signaling, the indication information is a bitmap including multiple blocks, wherein each block corresponds to a terminal equipment, and a starting position and/or size of each block is/are configured by high-layer signaling, wherein each block includes one or more bits, each bit corresponds to a group of CSI-RS ports or one CSI-RS port of the terminal equipment, and the number of the bits is configured by high-layer signaling.

For example, still by taking the bitmap of multiple blocks shown in FIG. 3 as an example, each block represents indication information of a terminal equipment, and a starting position and/or size of each block is/are given by a higher-layer parameter, for example, a higher-layer parameter in the existing standard may be used, or a new higher-layer parameter may be introduced, the present disclosure does not make limitations in this regard.

For example, each block corresponds to an activation/deactivation state of a CSI-RS port of a specific terminal equipment, for example each block e.g. includes X bits, each of the X bits corresponds to the activation/deactivation state of a CSI-RS port. In some implementations, for specific settings of CSI-RS ports, related arts may be referred to, the present disclosure does not make limitations in this regard.

Optionally, each block may further include information related to CSI-RS resources, for example including T bits (T may be equal to 0), the T bits indicate a CSI-RS resource set and/or CSI-RS resources corresponding to CSI-RS ports, optionally, in the case of T=0, a CSI-RS resource set and/or CSI-RS resources corresponding to CSI-RS ports is/are indicated by higher-layer information.

The description is made below by taking “T=0, i.e., not indicating a CSI-RS resource set and/or CSI-RS resources corresponding to CSI-RS ports” as an example.

For example, a terminal equipment may be configured with 32 CSI-RS ports, activation/deactivation states of a CSI-RS port are indicated via 32 bits, for example “0” represents deactivating the CSI-RS port, “1” represents activating the CSI-RS port; the meaning of “00000000000000001111111111111111” is activation of “CSI-RS port 16”-“CSI-RS port 31” and deactivating of “CSI-RS port 0”-“CSI-RS port 15”; optionally, the indication information may further indicate activation/deactivation states of a group of CSI-RS ports, the group of CSI-RS ports may be one or more CDM groups, for example “CSI-RS port 0”-“CSI-RS port 15” are Group 0; “CSI-RS port 16”-“CSI-RS port 31” are Group 1, or CSI-RS 32 port have four CDM groups in total, “CDM group 0” and “CDM group 1” are Group 0, “CDM group 2” and “CDM group 3” are Group 1.

For example, for two terminal equipments, the indication information is “‘10’ ‘01’”; by taking a first terminal equipment as an example, the indication information obtained by the first terminal equipment via higher-layer signaling is 4 bits in total, a starting position corresponding to the terminal equipment is the first bit, 2 bits in total and “CSI-RS port 0”-“CSI-RS port 15” are Group 0; “CSI-RS port 16”-“CSI-RS port 31” are Group 1, and the first to second bits are indication bits of the first terminal equipment, wherein ‘10’ indicates, for the first terminal equipment, activating “CSI-RS port 0”-“CSI-RS port 15” and deactivating “CSI-RS port 16”-“CSI-RS port 31”.

In addition, for a case that T is not equal to 0, it may be indicated in combination with the above modes of activating/deactivating a CSI-RS port and of activating/deactivating a CSI-RS resource, which is not repeated in the present disclosure.

In some implementations, if activation/deactivation states of a CSI-RS port of the terminal equipment need to be update, the indication information carries a corresponding block of the terminal equipment; and if the CSI-RS port of the terminal equipment does not need to be updated, the indication information does not carry the corresponding block of the terminal equipment. For example, if the terminal equipment fails to read relevant fields of the indication information via higher-layer signaling, it is considered that activation/deactivation states of the CSI-RS port do not need to be updated.

The above bit content is only exemplary description, “0” may also be set to represent activating a CSI-RS port and “1” to represent deactivating a CSI-RS port, the present disclosure does not make limitations in this regard.

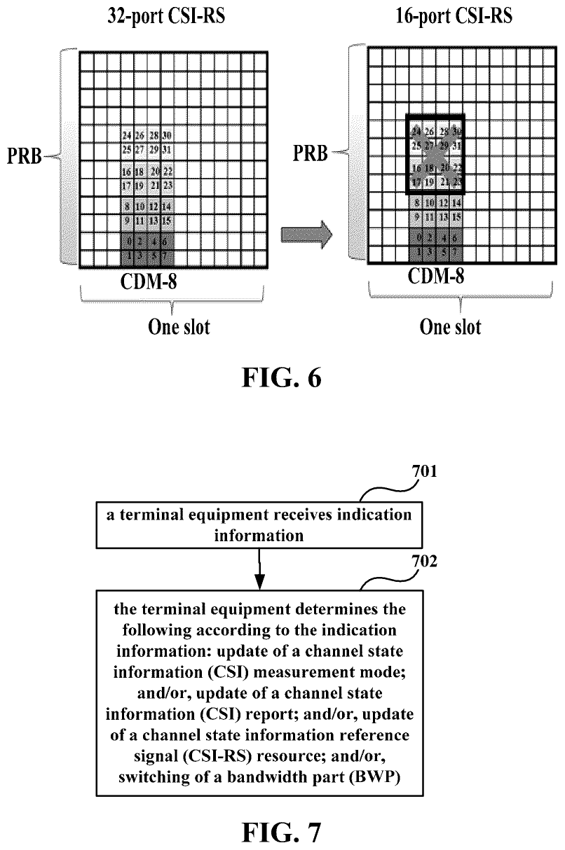

FIG. 6 is an exemplary diagram of update of a CSI-RS port in embodiments of the present disclosure.

As shown in FIG. 6, for a 32-port CSI-RS, for example, the 32-port CSI-RS may be supported via four CDM-8 and one resource, in which one resource of CDM-8 occupies 32 resource elements (REs), and for CDM-8, related arts may be referred to, the present disclosure does not make limitations in this regard. In the normal mode, a specific terminal equipment uses a 32-port CSI-RS, and in the power-saving mode, the terminal equipment uses a 16-port CSI-RS, for example, in a case where a network device shuts down some of spatial elements, a CSI-RS resource of the terminal equipment is changed from “activating CSI-RS ports 0-31” in FIG. 6 to “activating CSI-RS ports 0-15”, thereby update of a 32-port CSI-RS to a 16-port CSI-RS can be realized; for example, the mode indicated above is adopted and is not repeated here.

In some implementations, the semi-static signaling or the dynamic signaling is UE-specific signaling. For example, the network device may indicate activation/deactivation states of a CSI-RS port via X bits; each of the X bits indicates activation/deactivation states of a specific CSI-RS port, for example “1” is activation of a CSI-RS port; “0” is deactivation of a CSI-RS port; optionally, the network device may indicate activation/deactivation states of multiple groups of CSI-RS ports via X bits. For example, content of each block adopting the above implementations, as specific content of UE-specific signaling, is transmitted to a specific terminal equipment. For a specific indication method, the above implementations may be referred to, repeated description is omitted here.

In some implementations, after the first timer expires, the terminal equipment suspends a CSI-RS port before the service mode is changed; and after the first timer expires, the terminal equipment resumes the CSI-RS port before the service mode is changed.

For example, the network device transmits the configuration information via higher-layer signaling, such as RRC signaling, wherein the configuration information indicates an application time of the power-saving mode. For example, after reading RRC signaling, the terminal equipment obtains the application time of the energy-saving mode, the network device changes a service mode (for example, from the normal mode to the energy-saving mode) and transmits indication information to the terminal equipment (using said indication method), the terminal equipment updates an activated/deactivated CSI-RS port, suspends the activated/deactivated CSI-RS port in the normal mode, and resumes the normal mode after 300 ms, i.e., the first timer expires, and resumes the activated/deactivated CSI-RS port in the normal mode.

Thus, the terminal equipment may obtain specific content of the indication information, and may determine updated activated/deactivated CSI-RS ports.

The following text specifically describes how to indicate switching of a BWP.

In some implementations, the network device indicates, via the indication information indicating switching of a BWP and/or the first timer, a BWP after a service mode is changed.

In some implementations, in a case where the network device changes a service mode, the indication information indicates a BWP index after the service mode is changed, wherein the BWP index is configured by higher-layer information.

In some implementations, the BWP index is associated with a CSI report configuration index (CSI-ReportConfigId), wherein the CSI report configuration index (CSI-ReportConfigId) with which the BWP index is associated is configured by higher-layer information.

In some implementations, in a case where the network device changes the service mode, it is switched to activating a BWP to which the BWP index after the service mode is changed corresponds, and at the same time, activating CSI report associated with the associated CSI report configuration index (CSI-ReportConfigId) and deactivating CSI report associated with the CSI report configuration index (CSI-ReportConfigId) with which the BWP index before the service mode is changed is associated.

In some implementations, in a case where the semi-static signaling or the dynamic signaling is group signaling, the indication information is a bitmap including multiple blocks; wherein each block corresponds to a terminal equipment, and a starting position and/or size of each block is/are configured by high-layer signaling, wherein each block includes one or more bits, indicating an index of the switched BWP of the terminal equipment.

For example, still by taking the bitmap of multiple blocks shown in FIG. 3 as an example, each block represents indication information of a terminal equipment, and a starting position and/or size of each block is/are given by a higher-layer parameter, for example, a higher-layer parameter in the existing standard may be used, or a new higher-layer parameter may be introduced, the present disclosure does not make limitations in this regard.

For example, in a case where each block correspondingly opens or closes at least some of spatial elements, the terminal equipment is about to switch an index of a BWP, for example each block includes X bits corresponding to an index of a BWP. In some implementations, for settings of a BWP and its index, related arts may be referred to, the present disclosure does not make limitations in this regard.

For example, a terminal equipment is configured with four BWPs, indication information indicates a switched BWP index via two bits, for example “00” represents switching to BWP 0, “01” represents switching to BWP 1, “10” represents switching to BWP 2, and “11” represents switching to BWP 3. For example, higher-layer signaling configures BWP 0 to be associated with CSI 0, BWP 1 to be associated with CSI 1. After the service mode is changed to the power-saving mode, for example the indication information indicates “00”, correspondingly activates CSI 0 and deactivates CSI report of the terminal equipment in a normal mode, for example deactivates CSI 1 in the normal mode and configured by higher-layer signaling.

For example, for two terminal equipments, in a case where the service mode is changed, the indication information is “‘10’ ‘01’”; by taking a first terminal equipment as an example, the indication information obtained by the first terminal equipment via higher-layer signaling is 4 bits in total, wherein a size of each block is 2 bits, and the first to second bits are indication bits of the first terminal equipment, wherein ‘10’ indicates switching to BWP 2 for the first terminal equipment.

In some implementations, if a BWP of the terminal equipment needs to be switched, the indication information carries a corresponding block of the terminal equipment; and if a BWP of the terminal equipment does not need to be switched, the indication information does not carry the corresponding block of the terminal equipment. For example, if the terminal equipment fails to read relevant fields of the indication information via higher-layer signaling, it is considered that a BWP of the terminal equipment does not need to be switched.

In some implementations, the terminal equipment suspends a BWP index before the service mode is changed; and after the first timer expires, the terminal equipment resumes the BWP index before the service mode is changed.

For example, the network device transmits the configuration information via higher-layer signaling, such as RRC signaling, wherein the configuration information indicates an application time of the power-saving mode. For example, after reading RRC signaling, the terminal equipment obtains the application time of the energy-saving mode, the network device changes a service mode (for example, from the normal mode to the energy-saving mode) and transmits indication information to the terminal equipment (using said indication method), the terminal equipment switches a BWP index and suspends a BWP index in the normal mode, and resumes the normal mode after 300 ms, i.e., the first timer expires, and switches back to the BWP index in the normal mode.

Thus, the terminal equipment may obtain specific content of the indication information, and may determine a switched BWP index.

It should be noted that the above FIG. 4 to FIG. 6 are only schematic descriptions of the embodiments of the present disclosure, but the present disclosure is not limited to this. For example, an execution step of each operation may be adjusted appropriately, moreover other some operations may be increased or reduced. Persons skilled in the art can make appropriate modifications according to the above contents, not limited to the records in the above FIG. 4 to FIG. 6.

As may be known from the above embodiments, a network device changes a service mode and transmits indication information to a terminal equipment, wherein the indication information indicates: update of a CSI measurement mode; and/or, update of a CSI report; and/or, update of a CSI-RS resource; and/or, switching of a BWP. Thus, the terminal equipment may adapt to a changed service mode without ambiguity via the indication information, and accurately determine information such as update of a CSI measurement mode and/or update of CSI report and/or update of a CSI-RS resource and/or switching of a BWP, so as to further efficiently perform subsequent uplink data transmission or downlink data reception with the network device.

### Embodiments of a Second Aspect

Embodiments of the present disclosure provide an information reception method, which is described from a terminal equipment side, parts repeated with the embodiments of the first aspect are not described in detail.

FIG. 7 is a schematic diagram of an information reception method in embodiments of the present disclosure, as shown in FIG. 7, the method includes:
701, a terminal equipment receives indication information; and
702, the terminal equipment determines the following according to the indication information: update of a channel state information (CSI) measurement mode; and/or,
update of a channel state information (CSI) report; and/or, update of a channel state information reference signal (CSI-RS) resource; and/or, switching of a bandwidth part (BWP).

In some implementations, the service mode includes a normal mode and/or at least one energy-saving mode.

In some implementations, the terminal equipment further receives configuration information, wherein the configuration information configures a first timer associated with one of at least one energy-saving mode, wherein the first timer sets an application time of one of the at least one energy-saving mode.

In some implementations, the terminal equipment receives the indication information via semi-static signaling or dynamic signaling, wherein
the semi-static signaling or the dynamic signaling is group signaling, and the network device transmits the indication information to multiple terminal equipments via the group signaling; or, the semi-static signaling or the dynamic signaling is UE-specific signaling, and the network device transmits the indication information to a terminal equipment via the UE-specific signaling.

It should be noted that the above FIG. 7 is only schematic description of the embodiments of the present disclosure, but the present disclosure is not limited to this. For example, an execution step of each operation may be adjusted appropriately, moreover other some operations may be increased or reduced. Persons skilled in the art may make appropriate modifications according to the above contents, not limited to the records in the above FIG. 7.

As may be known from the above embodiments, a network device changes a service mode and transmits indication information to a terminal equipment, wherein the indication information indicates: update of a CSI measurement mode; and/or, update of a CSI report; and/or, update of a CSI-RS resource; and/or, switching of a BWP. Thus, the terminal equipment may adapt to a changed service mode without ambiguity via the indication information, and accurately determine information such as update of a CSI measurement mode and/or update of CSI report and/or update of a CSI-RS resource and/or switching of a BWP, so as to further efficiently perform subsequent uplink data transmission or downlink data reception with the network device.

### Embodiments of a Third Aspect

Embodiments of the present disclosure provide an information indication apparatus. The apparatus may be a network device, or may be one or more parts or components configured in the network device. The contents same as the embodiments of the first aspect are not repeated.

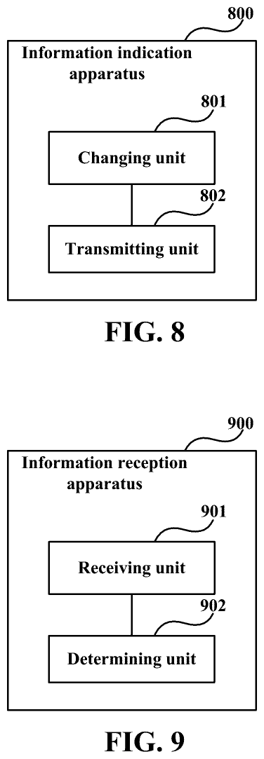

FIG. 8 is a schematic diagram of an information indication apparatus 800 in embodiments of the present disclosure, as shown in FIG. 8, an information indication apparatus 800 includes:
a changing unit 801 configured to change a service mode; and
a transmitting unit 802 configured to transmit indication information to a terminal equipment, wherein the indication information indicates: update of a channel state information (CSI) measurement mode; and/or, update of a channel state information (CSI) report; and/or, update of a channel state information reference signal (CSI-RS) resource; and/or, switching of a bandwidth part (BWP).

In some implementations, the service mode includes a normal mode and/or at least one energy-saving mode.

In some implementations, the transmitting unit 802 further transmits configuration information to the terminal equipment, wherein the configuration information configures a first timer associated with one of at least one energy-saving mode; wherein the first timer sets an application time of one of the at least one energy-saving mode.

In some implementations, the transmitting unit 802 transmits the indication information via semi-static signaling or dynamic signaling, wherein the semi-static signaling or the dynamic signaling is group signaling, and the network device transmits the indication information to multiple terminal equipments via the group signaling; or, the semi-static signaling or the dynamic signaling is UE-specific signaling, and the network device transmits the indication information to a terminal equipment via the UE-specific signaling.

In some implementations, the network device indicates, via the indication information indicating the update of CSI measurement mode and/or the first timer, whether the CSI measurement mode is changed or not.

In some implementations, in a case where the network device changes the service mode, the indication information indicating the update of the CSI measurement mode indicates, via a value of one or more bits, to change the CSI measurement mode, and/or, indicates, via another value of the one or more bits, not to change the CSI measurement mode.

In some implementations, the terminal equipment changes the CSI measurement mode after the first timer expires.

In some implementations, the network device activates/deactivates, via the indication information indicating the update of CSI report and/or the first timer, at least one CSI report.

In some implementations, in a case where the network device changes the service mode, the indication information indicating update of CSI report indicates to activate first CSI report and/or deactivate second CSI report, wherein the first CSI report and/or the second CSI report is/are configured by higher-layer information.

In some implementations, the terminal equipment suspends CSI report before the service mode is changed; and after the first timer expires, the terminal equipment resumes the CSI report before the service mode is changed.

In some implementations, the first CSI report and/or the second CSI report belong(s) to a first CSI report list which includes a CSI report configuration index (CSI-ReportConfigId), wherein the first CSI report list and the CSI report configuration index (CSI-ReportConfigId) are configured by higher-layer information.

In some implementations, the first CSI report and/or the second CSI report include(s): periodic CSI report, semi-persistent CSI report or non-periodic CSI report.

In some implementations, the CSI report configuration index (CSI-ReportConfigId) included in the first CSI report list is associated with a change of at least one of the following information: a CSI report period and offset; a resource used for CSI report; a period and offset of a CSI-RS resource to which the CSI report is bound; or a time-frequency resource of a CSI-RS resource to which the CSI report is bound.

In some implementations, the network device activates/deactivates, via the indication information indicating the update of a CSI-RS resource and/or the first timer, at least one CSI-RS resource.

In some implementations, in a case where the network device changes the service mode, the indication information indicating the update of a CSI-RS resource indicates to activate a first CSI-RS resource and/or deactivate a second CSI-RS resource, wherein the first CSI-RS resource and/or the second CSI-RS resource is/are configured by higher-layer information, wherein the first CSI-RS resource and/or the second CSI-RS resource is/are the same or different.

In some implementations, the terminal equipment suspends a CSI-RS resource before the service mode is changed; and after the first timer expires, the terminal equipment resumes the CSI-RS resource before the service mode is changed.

In some implementations, the first CSI-RS resource and/or the second CSI-RS resource belong(s) to a first CSI-RS resource set, wherein the first CSI-RS resource set includes CSI-RS resources, and/or CSI-RS ports; wherein an index of the first CSI-RS resource set and the number and indices of the CSI-RS resources included in the first CSI-RS resource set and/or the number and indices of the CSI-RS ports are configured by higher-layer information.

In some implementations, the network device indicates, via the indication information indicating switching of a BWP and/or the first timer, a BWP after the service mode is changed. In some implementations, in a case where the network device changes a service mode, the indication information indicating switching of a BWP indicates a BWP index after the service mode is changed; wherein the BWP index is configured by higher-layer information.

In some implementations, the terminal equipment further suspends a BWP index before the service mode is changed; and after the first timer expires, the terminal equipment resumes the BWP index before the service mode is changed.

In some implementations, the BWP index is associated with a CSI report configuration index (CSI-ReportConfigId), wherein the CSI report configuration index (CSI-ReportConfigId) with which the BWP index is associated is configured by higher-layer information.

In some implementations, in a case where the network device changes the service mode, it is switched to activating a BWP to which the bandwidth part (BWP) index after the service mode is changed corresponds, and at the same time, activating channel state information (CSI) report associated with the associated channel state information report configuration index (CSI-ReportConfigId) and deactivating channel state information (CSI) report associated with the channel state information report configuration index (CSI-ReportConfigId) with which the bandwidth part (BWP) index before the service mode is changed is associated.

In some implementations, in a case where the semi-static signaling or the dynamic signaling is group signaling, the indication information is a bitmap including multiple blocks; wherein each block corresponds to a terminal equipment, and a starting position and/or size of each block is/are configured by high-layer signaling.

For implementations of the information indication apparatus in FIG. 8, the embodiments of the first aspect may be referred to, detailed description is omitted here.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above only describes components or modules related to the present disclosure, but the present disclosure is not limited to this. The information indication apparatus 800 may further include other components or modules. For detailed contents of these components or modules, relevant technologies may be referred to.

Moreover, for the sake of simplicity, FIG. 8 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

As may be known from the above embodiments, a network device changes a service mode and transmits indication information to a terminal equipment, wherein the indication information indicates: update of a CSI measurement mode; and/or, update of CSI report; and/or, update of a CSI-RS resource; and/or, switching of a BWP. Thus, the terminal equipment may adapt to a changed service mode without ambiguity via the indication information, and accurately determine information such as update of a CSI measurement mode and/or update of CSI report and/or update of a CSI-RS resource and/or switching of a BWP, so as to further efficiently perform subsequent uplink data transmission or downlink data reception with the network device.

### Embodiments of a Fourth Aspect

Embodiments of the present disclosure provide an information reception apparatus. The apparatus for example may be a terminal equipment, or may be one or more parts or components configured in the terminal equipment. The contents same as the embodiments of the second aspect are not repeated.

FIG. 9 is a schematic diagram of an information reception apparatus 900 in embodiments of the present disclosure. As shown in FIG. 9, an information reception apparatus 900 includes:
a receiving unit 901 configured to receive indication information; and
a determining unit 902 configured to determine the following according to the indication information: update of a channel state information (CSI) measurement mode; and/or, update of a channel state information (CSI) report; and/or, update of a channel state information reference signal (CSI-RS) resource; and/or, switching of a bandwidth part (BWP).

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

In some implementations, the service mode includes a normal mode and/or at least one energy-saving mode.

In some implementations, the receiving unit 901 further receives configuration information, wherein the configuration information configures a first timer associated with one of at least one energy-saving mode; wherein the first timer sets an application time of one of the at least one energy-saving mode.

In some implementations, the receiving unit 901 receives the indication information via semi-static signaling or dynamic signaling, wherein the semi-static signaling or the dynamic signaling is group signaling, and the network device transmits the indication information to multiple terminal equipments via the group signaling; or, the semi-static signaling or the dynamic signaling is UE- specific signaling, and the network device transmits the indication information to a terminal equipment via the UE-specific signaling.

It's worth noting that the above only describes components or modules related to the present disclosure, but the present disclosure is not limited to this. The information reception apparatus 900 may further include other components or modules. For detailed contents of these components or modules, relevant technologies may be referred to.

Moreover, for the sake of simplicity, FIG. 9 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

As may be known from the above embodiments, a network device changes a service mode and transmits indication information to a terminal equipment, wherein the indication information indicates: update of a CSI measurement mode; and/or, update of CSI report; and/or, update of a CSI-RS resource; and/or, switching of a BWP. Thus, the terminal equipment may adapt to a changed service mode without ambiguity via the indication information, and accurately determine information such as update of a CSI measurement mode and/or update of CSI report and/or update of a CSI-RS resource and/or switching of a BWP, so as to further efficiently perform subsequent uplink data transmission or downlink data reception with the network device.

### Embodiments of a Fifth Aspect

Embodiments of the present disclosure further provide a communication system, FIG. 1 can be referred to, the contents same as the embodiments of the first to fourth aspects are not repeated.

In some embodiments, the communication system 100 at least may include: a terminal equipment 102 and/or a network device 101.

In some embodiments, for implementations of the terminal equipment 102, refer to the following network device 1000, and for implementations of the network device 101, refer to the following terminal equipment 1100.

Embodiments of the present disclosure further provide a network device, for example may be a base station, but the present disclosure is not limited to this, it may also be other network devices.

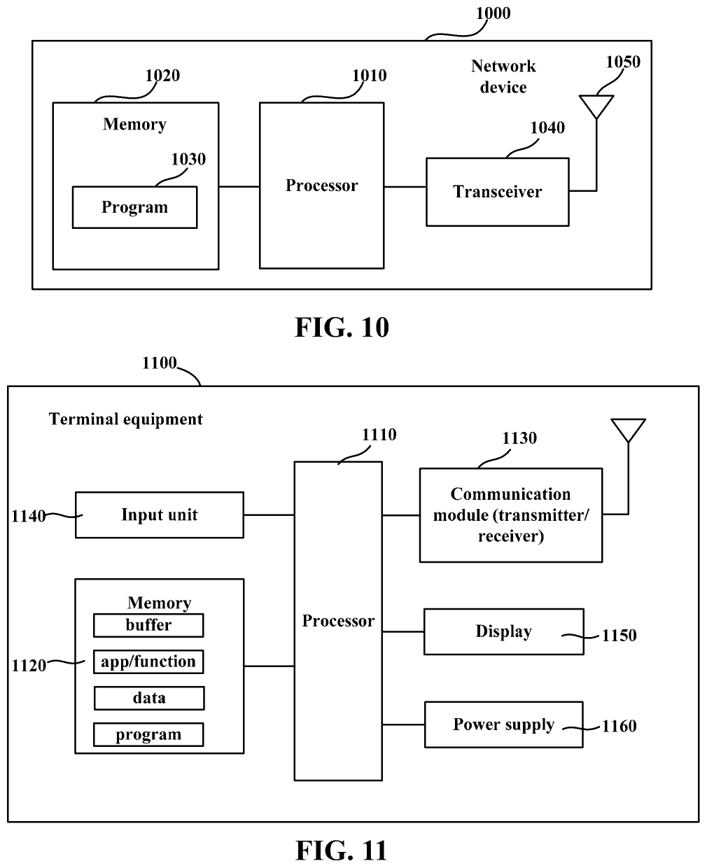

FIG. 10 is a composition schematic diagram of a network device in embodiments of the present disclosure. As shown in FIG. 10, the network device 1000 may include: a processor 1010 (such as a central processing unit (CPU)) and a memory 1020; the memory 1020 is coupled to the processor 1010. The memory 1020 may store various data; moreover, also stores a program 1030 for information processing, and executes the program 1030 under the control of the processor 1010.

For example, the processor 1010 may be configured to execute a program to implement the information indicating method as described in the embodiments of the first aspect.

In addition, as shown in FIG. 10, the network device 1000 may further include: a transceiver 1040 and an antenna 1050, etc., wherein the functions of said components are similar to relevant arts, which are not repeated here. It's worth noting that the network device 1000 does not have to include all the components shown in FIG. 10. Moreover, the network device 1000 may further include components not shown in FIG. 10, related arts may be referred to.

Embodiments of the present disclosure further provide a terminal equipment, but the present disclosure is not limited to this, it may also be other device.

FIG. 11 is a schematic diagram of a terminal equipment in embodiments of the present disclosure. As shown in FIG. 11, the terminal equipment 1100 may include a processor 1110 and a memory 1120; the memory 1120 stores data and programs, and is coupled to the processor 1110. It's worth noting that this figure is exemplary; other types of structures may also be used to supplement or replace this structure, so as to realize a telecommunication function or other functions.

For example, the processor 1110 may be configured to execute a program to implement the information reception method as described in the embodiments of the second aspect.

As shown in FIG. 11, the terminal equipment 1100 may further include: a communication module 1130, an input unit 1140, a display 1150 and a power supply 1160. The functions of said components are similar to related arts, which are not repeated here. It's worth noting that the terminal equipment 1100 does not have to include all the components shown in FIG. 11, said components are not indispensable. Moreover, the terminal equipment 1100 may further include components not shown in FIG. 11, related arts may be referred to.

Embodiments of the present disclosure further provide a computer program, wherein when a network device executes the program, the program enables the terminal equipment to execute the information indication method described in the embodiments of the first aspect.

Embodiments of the present disclosure further provide a storage medium in which a computer program is stored, wherein the computer program enables a network device to execute the information indication method described in the embodiments of the first aspect.

Embodiments of the present disclosure further provide a computer program, wherein when a terminal equipment executes the program, the program enables the terminal equipment to execute the information reception method described in the embodiments of the second aspect.

Embodiments of the present disclosure further provide a storage medium in which a computer program is stored, wherein the computer program enables a terminal equipment to execute the information reception method described in the embodiments of the second aspect.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

As for the implementations including the above embodiments, the following supplements are further disclosed:
1. An information indication method, applicable to a network device, the information indication method including:
the network device changes a service mode, and
transmits indication information to a terminal equipment, wherein the indication information is used to indicate:
update of a CSI measurement mode; and/or,
update of a CSI report; and/or,
update of a CSI-RS resource; and/or,
switching of a BWP.
2. The method according to Supplement 1, wherein the service mode includes a normal mode and/or at least one energy-saving mode.
3. The method according to Supplement 2, wherein the network device further transmits configuration information to the terminal equipment, wherein the configuration information configures a first timer related to one of the at least one energy-saving mode,
wherein the first timer sets an application time of one of the at least one energy-saving mode.
4. The method according to any one of Supplements 1-3, wherein the network device transmits the indication information via semi-static signaling or dynamic signaling; wherein
the semi-static signaling or dynamic signaling is group signaling, and the network device transmits the indication information to multiple terminal equipments via the group signaling; or
the semi-static signaling or dynamic signaling is UE-specific signaling, and the network device transmits the indication information to a terminal equipment via the UE-specific signaling.
5. The method according to any one of Supplements 1-4, wherein the network device indicates, via the indication information indicating the update of CSI measurement mode and/or the first timer, whether the CSI measurement mode is changed or not.
6. The method according to Supplement 5, wherein in a case where the network device changes the service mode, the indication information indicating the update of the CSI measurement mode indicates, via a value of one or more bits, to change the CSI measurement mode, and/or, indicates, via another value of the one or more bits, not to change the CSI measurement mode.
7. The method according to Supplement 6, wherein the terminal equipment changes the CSI measurement mode after the first timer expires.
8. The method according to Supplement 4, wherein the network device activates/deactivates, via the indication information indicating the update of CSI report and/or the first timer, at least one CSI report.
9. The method according to Supplement 8, wherein in a case where the network device changes the service mode, the indication information indicating update of CSI report indicates to activate first CSI report and/or deactivate second CSI report, wherein the first CSI report and/or the second CSI report is/are configured by higher-layer information.
10. The method according to Supplement 9, wherein the terminal equipment suspends CSI report before the service mode is changed; and
after the first timer expires, the terminal equipment resumes the CSI report before the service mode is changed.
11. The method according to any one of Supplements 8-10, wherein the first CSI report and/or the second CSI report belong(s) to a first CSI report list which includes a CSI report configuration index (CSI-ReportConfigId), wherein the first CSI report list and the CSI report configuration index (CSI-ReportConfigId) are configured by higher-layer information.
12. The method according to any one of Supplements 8-11, wherein the first CSI report and/or the second CSI report include(s): periodic CSI report, semi-persistent CSI report or non-periodic CSI report.

13. The method according to any one of Supplements 8-11, wherein the CSI report configuration index (CSI-ReportConfigId) included in the first CSI report list is associated with a change of at least one piece of the following information:
a CSI report period and offset;
a resource used for a CSI report;
a period and offset of a CSI-RS resource to which the CSI report is bound; or
a time-frequency resource of a CSI-RS resource to which the CSI report is bound.
14. The method according to Supplement 4, wherein the network device activates/deactivates, via the indication information indicating the update of a CSI-RS resource and/or the first timer, at least one CSI-RS resource.
15. The method according to Supplement 14, wherein in a case where the network device changes the service mode, the indication information indicating the update of a CSI-RS resource indicates to activate a first CSI-RS resource and/or deactivate a second CSI-RS resource, wherein the first CSI-RS resource and/or the second CSI-RS resource is/are configured by higher-layer information; wherein the first CSI-RS resource and/or the second CSI-RS resource is/are the same or different.
16. The method according to Supplement 14, wherein the terminal equipment suspends a CSI-RS resource before the service mode is changed; and
after the first timer expires, the terminal equipment resumes the CSI-RS resource before the service mode is changed.
17. The method according to any one of Supplements 14-16, wherein the first CSI-RS resource and/or the second CSI-RS resource belong(s) to a first CSI-RS resource set,
wherein the first CSI-RS resource set includes CSI-RS resources, and/or CSI-RS ports, and
wherein an index of the first CSI-RS resource set and the number and indices of the CSI-RS resources included in the first CSI-RS resource set and/or the number and indices of the CSI-RS ports are configured by higher-layer information.
18. The method according to Supplement 4, wherein the network device indicates, via the indication information indicating the switching of a BWP and/or the first timer, a BWP after the service mode is changed.
19. The method according to Supplement 18, wherein in a case where the network device changes the service mode, the indication information indicating the switching of a BWP indicates a BWP index after the service mode is changed; wherein the BWP index is configured by higher-layer information.
20. The method according to Supplement 19, wherein the terminal equipment suspends a BWP index before the service mode is changed; and
after the first timer expires, the terminal equipment resumes the BWP index before the service mode is changed.
21. The method according to any one of Supplements 18-20, wherein the BWP index is associated with a CSI report configuration index (CSI-ReportConfigId), wherein the CSI report configuration index (CSI-ReportConfigId) with which the BWP index is associated is configured by higher-layer information.
22. The method according to Supplement 21, wherein in a case where the network device changes the service mode, it is switched to activating a BWP to which the bandwidth part (BWP) index after the service mode is changed corresponds, and at the same time, activating channel state information (CSI) report associated with the associated channel state information report configuration index (CSI-ReportConfigId) and deactivating channel state information (CSI) report associated with the channel state information report configuration index (CSI-ReportConfigId) with which the bandwidth part (BWP) index before the service mode is changed is associated.
23. The method according to Supplements 1-21, wherein in a case where the semi-static signaling or the dynamic signaling is group signaling, the indication information is a bitmap including multiple blocks; wherein each block corresponds to a terminal equipment, and a starting position and/or size of each block is/are configured by high-layer signaling.
24. An information reception method, applicable to a terminal equipment, the information reception method including:
the terminal equipment receives indication information; and
the terminal equipment determines according to the indication information:
update of a CSI measurement mode; and/or,
update of a CSI report; and/or,
update of a CSI-RS resource; and/or,
switching of a BWP.
25. The method according to Supplement 24, wherein the service mode includes a normal mode and/or at least one energy-saving mode.
26. The method according to Supplement 25, wherein the terminal equipment further receives configuration information, wherein the configuration information configures a first timer related to one of the at least one energy-saving mode,
wherein the first timer sets an application time of one of the at least one energy-saving mode.
27. The method according to any one of Supplements 24-26, wherein the terminal equipment receives the indication information via semi-static signaling or dynamic signaling, wherein
the semi-static signaling or dynamic signaling is group signaling, and the network device transmits the indication information to multiple terminal equipments via the group signaling; or
the semi-static signaling or dynamic signaling is UE-specific signaling, and the network device transmits the indication information to a terminal equipment via the UE-specific signaling.
28. A terminal equipment, including a memory and a processor, the memory storing a computer program, and the processor being configured to execute the computer program to implement the information reception method according to any one of Supplements 24-27.
29. A network device, including a memory and a processor, the memory storing a computer program, and the processor being configured to execute the computer program to implement the information indication method for acquiring data according to any one of Supplements 1-23.

What is claimed is:

1. An information indication apparatus, applicable to a network device, the apparatus comprising:
a transmitter configured to transmit indication information to a terminal equipment, wherein the indication information indicates: activation/deactivation of a channel state information (CSI) report in a list of CSI reports; and, enabling/disabling of at least one channel state information reference signal (CSI-RS) resource within a CSI-RS resource set; and
a receiver, configured to receive a channel state information (CSI) report on a physical uplink shared channel (PUSCH) or a physical uplink control channel (PUCCH).

2. The apparatus according to claim 1, wherein the transmitter transmits the indication information via semi-static signaling and/or dynamic signaling.

3. The apparatus according to claim 2, wherein, the dynamic signaling is a downlink control information (DCI) indicating activation/deactivation of the channel state information (CSI) report;
or, the semi-static signaling is an MAC CE (Control Element) indicating activation/deactivation of the channel state information (CSI) report;
or, the semi-static signaling is a radio resource control (RRC) signaling indicating enabling/disabling of the channel state information reference signal (CSI-RS) resource.

4. The apparatus according to claim 2, wherein the semi-static signaling or dynamic signaling is group signaling, and the transmitter transmits the indication information to a plurality of terminal equipments via the group signaling; or
the semi-static signaling or dynamic signaling is UE-specific signaling, and the transmitter transmits the indication information to a terminal equipment via the UE-specific signaling.

5. The apparatus according to claim 1, wherein at least one channel state information (CSI) report is activated/deactivated, via the indication information.

6. The apparatus according to claim 1, wherein the indication information is used to activate a first channel state information (CSI) report and/or deactivate a second channel state information (CSI) report, wherein the first channel state information (CSI) report and/or the second channel state information (CSI) report is/are configured by higher-layer information.

7. The apparatus according to claim 6, wherein the first channel state information (CSI) report and/or the second channel state information (CSI) report belong(s) to a first channel state information (CSI) report list,
wherein the first channel state information (CSI) report list includes one or more channel state information report configuration identifiers.

8. The apparatus according to claim 7, wherein the first channel state information (CSI) report list and the one or more channel state information report configuration identifiers are configured by higher-layer information.

9. The apparatus according to claim 7, wherein a channel state information report configuration identifier included in the first channel state information (CSI) report list is associated with
a resource used for the channel state information (CSI) report, and/or,
a time-frequency resource of a channel state information reference signal (CSI-RS) resource corresponding to the channel state information (CSI) report.

10. The apparatus according to claim 1, wherein at least one channel state information reference signal (CSI-RS) resource is enabled/disabled, via the indication information.

11. The apparatus according to claim 10, wherein the indication information is used to enable a first channel state information reference signal (CSI-RS) resource and/or disable a second channel state information reference signal (CSI-RS) resource;
wherein the first channel state information reference signal (CSI-RS) resource and/or the second channel state information reference signal (CSI-RS) resource is/are configured by higher-layer information.

12. The apparatus according to claim 11, wherein the first channel state information reference signal (CSI-RS) resource and/or the second channel state information reference signal (CSI-RS) resource are different.

13. The apparatus according to claim 11, wherein the first channel state information reference signal (CSI-RS) resource and/or the second channel state information reference signal (CSI-RS) resource belong(s) to a first channel state information reference signal (CSI-RS) resource set.

14. The apparatus according to claim 1, wherein the channel state information reference signal (CSI-RS) resource set includes channel state information reference signal (CSI-RS) resources, or, channel state information reference signal (CSI-RS) ports.

15. The apparatus according to claim 14, wherein at least one of the following information are configured by higher-layer information:
an index of the channel state information reference signal (CSI-RS) resource set;
the number and indices of the channel state information reference signal (CSI-RS) resources included in the channel state information reference signal (CSI-RS) resource set;
the number and/or indices of the channel state information reference signal (CSI-RS) ports.

16. The apparatus according to claim 14, wherein the channel state information reference signal (CSI-RS) resources refer to a list of channel state information reference signal (CSI-RS) resources configured by higher-layer information.

17. The apparatus according to claim 14, wherein a value of bits in the indication information indicates that a corresponding CSI-RS port is enabled and/or another value of bits in the indication information indicates that a corresponding CSI-RS port is disabled.

18. The apparatus according to claim 17, wherein the indication information comprises a bitmap which contains a plurality of bits.

19. An information reception apparatus, applicable to a terminal equipment, the apparatus comprising:
a receiver configured to receive indication information; wherein the indication information indicates: activation/deactivation of a channel state information (CSI) report in a list of CSI reports, and, enabling/disabling of at least one channel state information reference signal (CSI-RS) resource within a CSI-RS resource set; and
a transmitter configured to transmit a channel state information (CSI) report on a physical uplink shared channel (PUSCH) or a physical uplink control channel (PUCCH).

20. A communication system, comprising:
a network device configured to transmit indication information; and receive a channel state information (CSI) report on a physical uplink shared channel (PUSCH) or a physical uplink control channel (PUCCH); and
a terminal equipment configured to receive the indication information and transmit the channel state information (CSI) report;
wherein the indication information indicates: activation/deactivation of a channel state information (CSI) report in a list of CSI reports, and, enabling/disabling of at least one channel state information reference signal (CSI-RS) resource within a CSI-RS resource set.
